(19) United States
(12) Patent Application Publication
(10) Pub. No.: US 2026/0129119 A1
(43) Pub. Date: May 7, 2026

(54) METHOD AND SYSTEM FOR DETECTION OF A DEEPFAKE WITHIN AN ELECTRONIC AUDIO STREAM VIA AN INTEGRATED SECURE FRAMEWORK ENVIRONMENT

(71) Applicant: JPMorgan Chase Bank, N.A., New York, NY (US)

(72) Inventors: Rohit NILEKAR, Edison, NJ (US); Mohammed Ahamed MOHISEEN, Hyderabad (IN); Sagrika KHATIWALA, Edison, NJ (US)

(73) Assignee: JPMorgan Chase Bank, N.A., New York, NY (US)

(21) Appl. No.: 18/999,525

(22) Filed: Dec. 23, 2024

(30) Foreign Application Priority Data
Nov. 4, 2024 (IN) 202411084052

(51) Int. Cl. H04M 3/22; G10L 17/26

(52) U.S. Cl. CPC H04M 3/2281; G10L 17/26; H04M 2203/6027

(57) ABSTRACT

A method and system for detection of a deepfake within an electronic audio stream by an integrated secure framework environment may be provided. The method may include receiving and routing the electronic audio stream to a microservice communications platform and a session border controller (SBC) agent. The method may also include generating a first fork and a second fork of the electronic audio stream for transmission to a proxy interactive voice response (IVR) platform and creating an enhanced electronic audio stream. The method may also include generating an integrated multi-operation platform and transmitting the enhanced electronic audio stream to the integrated multi-operation platform. The method may also include generating at least one replica of the enhanced electronic audio stream to each of at least one downstream machine learning (ML) environment and performing the detection of the deepfake for the at least one replica by a ML model.

### CROSS-REFERENCE TO RELATED APPLICATIONS

This application claims priority benefit from Indian Application No. 202411084052, filed Nov. 4, 2024 in the India Patent Office, which is hereby incorporated by reference in its entirety.

### FIELD OF DISCLOSURE

This technology generally relates to methods and systems for detection of a deepfake within an electronic audio stream via an integrated secure framework environment.

### BACKGROUND INFORMATION

The prevalence of artificial intelligence (AI)/machine learning (ML) programs and tools makes it exceedingly easy to impersonate the audio or voice of a person. That is, creating a deepfake of a person's voice. Deepfakes are highly problematic when such impersonations are often used for nefarious purposes, e.g., in scams, frauds, misinformation campaigns, etc. Indeed, for financial institutions, the implications of deepfakes can have a significant impact of on the person whose audio or voice was impersonated.

Consider, for example, a customer whose audio or voice has been impersonated using an AI/ML programs or tools. That is, a deepfake of the customer's audio or voice. A fraudster can then use this deepfake to contact the financial institution to gain access to the customer's financial information and accounts to steal the customer's money. Additionally, the financial institution can also be impacted by being subjected to lawsuits and regulatory violations. Thus, the consequences for the customer and the financial institution can be dire. Given the increasing prevalence of AI/ML programs and tools capable of performing deepfakes and the ease with which such deepfakes can be generated, there is a heightened need to detect deepfakes.

While there may be models in the status quo that may provide individual services or applications relating to detecting deepfakes, the status quo does not provide a manner in which these models may be integrated with a framework or platform that is presently used by an enterprise, e.g., the financial institution, in handling real-time audio or voice from a user/customer.

Therefore, to protect the customers and also the financial institutions, a platform associated with call communications capable of detecting deepfakes in real-time for real-time audio or voice of a customer in order to distinguish audio or voice of the customer versus that of a deepfake. Accordingly, there is a need for techniques to detect a deepfake of audio streams in a secure environment.

### SUMMARY

The present disclosure, through one or more of its various aspects, embodiments, and/or specific features or sub-components, provides, inter alia, various systems, servers, devices, methods, media, programs, and platforms for detection of a deepfake within an electronic audio stream.

According to an aspect of the present disclosure, a method for detection of a deepfake within an electronic audio stream by an integrated secure framework environment may be provided. The method may be implemented by at least one processor. The method may include receiving the electronic audio stream from a user and routing the electronic audio stream to a microservice communications platform and a session border controller (SBC) agent, and generating a secured call audio of the electronic audio stream from the SBC agent. The method may also include generating a first fork audio stream of the electronic audio stream from the microservice communications platform and a second fork audio stream of the electronic audio stream from the SBC agent. The method may also include transmitting the first fork audio stream and the second fork audio stream to a proxy interactive voice response (IVR) platform, and attaching business logic key-value pairs to the first fork audio stream and the second fork audio stream at the proxy IVR platform to create an enhanced electronic audio stream. The method may also include generating an integrated multi-operation platform comprising an encryption protocol standard framework and a remote procedural call (RPC) framework, and transmitting the enhanced electronic audio stream and the secured call audio to the integrated multi-operation platform. The method may also include generating at least one replica of the enhanced electronic audio stream at the integrated multi-operation platform for transmission to each of at least one downstream machine learning (ML) environment. The method may also include performing the detection of the deepfake for the at least one replica by a ML model operating in the at least one downstream ML environment.

The encryption protocol standard framework may include a session initiation protocol recording (SIPREC) framework. The at least one downstream ML environment may include a first ML environment configured to perform the detection of the deepfake, a first redaction, and a first transcription of the at least one replica and a second ML environment configured to perform a second redaction and a second transcription of the at least one replica.

The method may further include receiving the at least one replica at a remote conferencing platform in the first ML environment, and performing dual operations on the at least one replica. A first operation of the dual operations may include performing the deepfake detection of the at least one replica by a ML model. A second operation of the dual operations may include performing the first redaction of the at least one replica that generates a first redacted version of the at least one replica, and performing the first transcribing of the first redacted version for storage on a cloud storage platform.

The method may further include receiving the at least one replica at a voice transcription handler in the second ML environment, performing the second redaction of the at least one replica that generates a second redacted version of the at least one replica, and performing the second transcribing of the second redacted version for storage on a cloud storage platform.

The transmitting the enhanced electronic audio stream and the secured call audio to the integrated multi-operation platform nay include transmitting the enhanced electronic audio stream to the SIPREC framework, and transmitting the secured call audio to the RPC framework.

The generating the secured call audio may include securing the electronic audio stream based on a secure real-time transport protocol (SRTP) that provides security protections to the electronic audio stream. The security protections may include at least one from among validation, authentication, encryption, and replay protection of the electronic audio stream.

The generating the at least one replica may further include generating a first metadata from the at least one replica via the SIPREC framework for input into the first ML environment.

The generating the at least one replica may further include converting the secured call audio with a first format comprising the SRTP to a second format with a RPC protocol via the RPC framework, and transmitting the converted secured call audio to the first ML environment.

The generating the at least one replica may further include generating an unredacted call audio of the secured call audio and a second metadata of the unredacted call audio via the RPC framework for input into the second ML environment.

The method may further include generating a control metadata via the encryption protocol standard framework for input into the RPC framework.

According to another embodiment, a computing apparatus for detection of a deepfake within of an electronic audio stream by an integrated secure framework environment may be provided. The computing apparatus may include: a processor; a memory; a display; and a communication interface coupled to each of the processor, the memory, and the display.

The processor may be configured to implement the integrated secure framework environment to receive the electronic audio stream from a user, and route the electronic audio stream to a microservice communications platform and a session border controller (SBC) agent and generating a secured call audio of the electronic audio stream from the SBC agent. The processor may be further configured to generate a first fork audio stream of the electronic audio stream from the microservice communications platform and a second fork audio stream of the electronic audio stream from the SBC agent. The processor may be further configured to transmit the first fork audio stream and the second fork audio stream to a proxy interactive voice response (IVR) platform, and attach business logic key-value pairs to the first fork audio stream and the second fork audio stream at the proxy IVR platform to create an enhanced electronic audio stream. The processor may be further configured to generate an integrated multi-operation platform comprising an encryption protocol standard framework and a remote procedural call (RPC) framework, and transmit the enhanced electronic audio stream and the secured call audio to the integrated multi-operation platform. The processor may be further configured to generate at least one replica of the enhanced electronic audio stream at the integrated multi-operation platform for transmission to each of at least one downstream machine learning (ML) environment, and perform the detection of the deepfake for the at least one replica by a ML model operating in the at least one downstream ML environment.

The encryption protocol standard framework may include a session initiation protocol recording (SIPREC) framework. The at least one downstream ML environment may include a first ML environment configured to perform the detection of the deepfake, a first redaction, and a first transcription of the at least one replica and a second ML environment configured to perform a second redaction and a second transcription of the at least one replica.

The processor may be further configured to implement the integrated secure framework environment to receive the at least one replica at a remote conferencing platform in the first ML environment, and perform dual operations on the at least one replica. The processor may perform a first operation of the dual operations by performing the deepfake detection of the at least one replica by a ML model. The processor may perform a second operation of the dual operations by: performing the first redaction of the at least one replica that generates a first redacted version of the at least one replica, and performing the first transcribing of the first redacted version for storage on a cloud storage platform.

The processor may be further configured to implement the integrated secure framework environment to receive the at least one replica at a voice transcription handler in the second ML environment, perform the second redaction of the at least one replica that generates a second redacted version of the at least one replica, and perform the second transcribing of the second redacted version for storage on a cloud storage platform.

The processor may be further configured to implement the integrated secure framework environment to transmit the enhanced electronic audio stream and the secured call audio to the integrated multi-operation platform by transmitting the enhanced electronic audio stream to the SIPREC framework, and transmitting the secured call audio to the RPC framework. The processor may be further configured to generate the secured call audio by securing the electronic audio stream based on a secure real-time transport protocol (SRTP) that provides security protections to the electronic audio stream. The security protections may include at least one from among validation, authentication, encryption, and replay protection of the electronic audio stream.

The processor may be further configured to implement the integrated secure framework environment to generate the at least one replica further by generating a first metadata from the at least one replica via the SIPREC framework for input into the first ML environment and converting the secured call audio with a first format comprising the SRTP to a second format with a RPC protocol via the RPC framework. The processor may be further configured to generate the at least one replica further by transmitting the converted secured call audio to the first ML environment, and generating an unredacted call audio of the secured call audio and a second metadata of the unredacted call audio via the RPC framework for input into the second ML environment.

According to yet another embodiment, non-transitory computer readable storage medium storing instructions for detection of a deepfake within an electronic audio stream by an integrated secure framework environment may be provided. The non-transitory computer readable storage medium comprising executable code which, when executed by a processor, may cause the processor to implement the integrated secure framework environment to receive the electronic audio stream from a user, and route the electronic audio stream to a microservice communications platform and a session border controller (SBC) agent and generating a secured call audio of the electronic audio stream from the SBC agent. The executable code may further cause the processor to generate a first fork audio stream of the electronic audio stream from the microservice communications platform and a second fork audio stream of the electronic audio stream from the SBC agent. The executable code may further cause the processor to transmit the first fork audio stream and the second fork audio stream to a proxy interactive voice response (IVR) platform, and attach business logic key-value pairs to the first fork audio stream and the second fork audio stream at the proxy IVR platform to create an enhanced electronic audio stream. The executable code may further cause the processor to generate an integrated multi-operation platform comprising an encryption protocol standard framework and a remote procedural call (RPC) framework, and transmit the enhanced electronic audio stream and the secured call audio to the integrated multi-operation platform. The executable code may further cause the processor to generate at least one replica of the enhanced electronic audio stream at the integrated multi-operation platform for transmission to each of at least one downstream machine learning (ML) environment, and perform the detection of the deepfake for the at least one replica by a ML model operating in the at least one downstream ML environment.

The encryption protocol standard framework may include a session initiation protocol recording (SIPREC) framework. The at least one downstream ML environment may include a first ML environment configured to perform the detection of the deepfake, a first redaction, and a first transcription of the at least one replica and a second ML environment configured to perform a second redaction and a second transcription of the at least one replica.

The executable code may further cause the processor to implement the integrated secure framework environment to receive the at least one replica at a remote conferencing platform in the first ML environment, and perform dual operations on the at least one replica. The executable code may further cause the processor to perform a first operation of the dual operations by performing the deepfake detection of the at least one replica by a ML model. The executable code may further cause the processor to perform a second operation of the dual operations by performing the first redaction of the at least one replica that generates a first redacted version of the at least one replica, and performing the first transcribing of the first redacted version for storage on a cloud storage platform.

The executable code may further cause the processor to implement the integrated secure framework environment to receive the at least one replica at a voice transcription handler in the second ML environment, perform the second redaction of the at least one replica that generates a second redacted version of the at least one replica, and perform the second transcribing of the second redacted version for storage on a cloud storage platform.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a system diagram of a computer system.

FIG. 2 illustrates a network diagram of a network environment.

FIG. 3 illustrates a diagram of a system environment according to an embodiment for detection of a deepfake within an electronic audio stream.

FIG. 4 illustrates a flowchart of a process diagram detection for detection of a deepfake within an electronic audio stream according to an embodiment for detection of a deepfake within an electronic audio stream.

FIG. 5 illustrates an example comprehensive framework for detection of a deepfake within an electronic audio stream according to an embodiment.

FIG. 6 illustrates an example expanded framework with machine learning (ML) capabilities for detection of a deepfake within an electronic audio stream according to an embodiment.

FIG. 7a illustrates an example overview framework expanded with machine learning (ML) capabilities for detection of a deepfake within an electronic audio stream according to an embodiment.

FIG. 7b illustrates a continuation of an example overview framework expanded with machine learning (ML) capabilities for detection of a deepfake within an electronic audio stream according to an embodiment.

### DETAILED DESCRIPTION

The prevalence of artificial intelligence (AI)/machine learning (ML) programs and tools makes it exceedingly easy to impersonate the audio or voice of a person. That is, creating a deepfake of a person's voice. Deepfakes are highly problematic when such impersonations are often used for nefarious purposes, e.g., in scams, frauds, misinformation campaigns, etc. Indeed, for financial institutions, the implications of deepfakes can have a significant impact of on the person whose audio or voice was impersonated.

Consider, for example, a customer whose audio or voice has been impersonated using an AI/ML programs or tools. That is, a deepfake of the customer's audio or voice. A fraudster can then use this deepfake to contact the financial institution to gain access to the customer's financial information and accounts to steal the customer's money. Additionally, the financial institution can also be impacted by being subjected to lawsuits and regulatory violations. Thus, the consequences for the customer and the financial institution can be dire. Given the increasing prevalence of AI/ML programs and tools capable of performing deepfakes and the ease with which such deepfakes can be generated, there is a heightened need to detect deepfakes.

While there may be models in the status quo that may provide individual services or applications relating to detecting deepfakes, the status quo does not provide a manner in which these models may be integrated with a framework or platform that is presently used by an enterprise, e.g., the financial institution, in handling real-time audio or voice from a user/customer.

Therefore, to protect the customers and also the financial institutions, a platform associated with call communications capable of detecting deepfakes in real-time for real-time audio or voice of a customer in order to distinguish audio or voice of the customer versus that of a deepfake. Accordingly, there is a need for techniques to detection of a deepfake within an electronic audio stream via an integrated secure framework environment.

The present application provides an integrated secure framework environment that may enable ML models to detect whether the electronic audio stream coming from a customer to a contact center of a financial institution may be a computer generated voice (such as an AI generated voice, i.e., a deepfake) or the customer's real voice.

That is, to address these challenges in the status quo, the present application provides a technological improvement of the status quo because it enables the integration of external/additional services or models with a framework or platform currently being used by an enterprise, e.g., the financial institution, that is capable of detecting deepfakes using real-time audio or voice from a user/customer. Notably, the present application is agnostic to external/additional services or models since it may leverage existing telephony protocols (e.g., session initiation protocol (SIP) or secure real-time transport protocol (SRTP). Further details of the present application are provided below. Additionally, the present application may be integrated with any cloud or remote servers that supports standard telephony protocols and can run ML models for the purpose of performing deepfake detections and transcriptions.

Through one or more of its various aspects, embodiments and/or specific features or sub-components of the present disclosure, are intended to bring out one or more of the advantages as specifically described above and noted below. Further details of the present application are provided below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

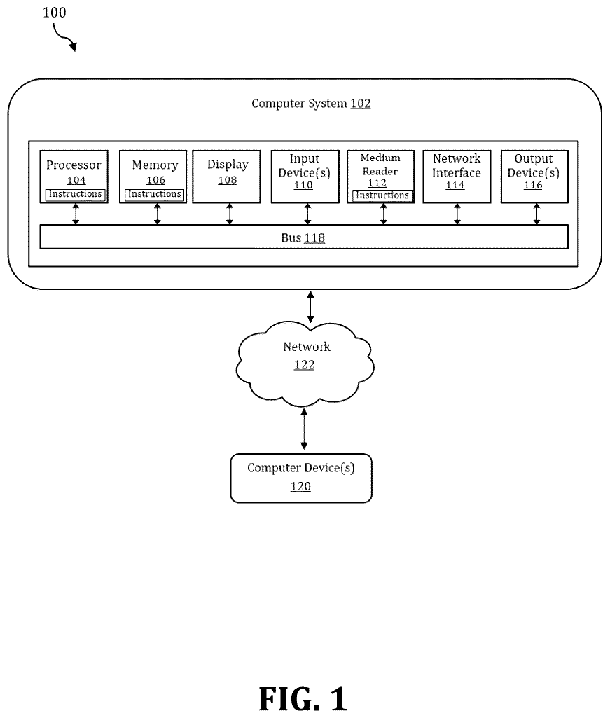

FIG. 1 illustrates a system 100 diagram of a computer system 102 for use in accordance with the embodiments described herein. The system 100 may be generally shown and may include a computer system 102, which may be generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 may be illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 may be an article of manufacture and/or a machine component. The processor 104 may be configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that may store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, digital optical disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which may be configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but not limited to, a local area network, a wide area network, the Internet, a telephony network, a short-range network, or any other network commonly known and understood in the art. The short-range network may include, for example, short-range wireless technology standard used for exchanging data between fixed devices and mobile devices over short distances, low-power wireless ad-hoc mesh networks for linking together, infrared, near field communication, ultra-wideband, or any combination thereof. Those skilled in the art appreciate that additional networks 122 which are known and understood may additionally or alternatively be used and that the networks 122 are not limiting or exhaustive. Also, while the network 122 may be illustrated in FIG. 1 as a wireless network, those skilled in the art appreciate that the network 122 may also be a wired network.

The additional computer device 120 may be illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that may be capable of executing a set of instructions, sequential or otherwise, that specify actions to be taken by that device. Of course, those skilled in the art appreciate that the above-listed devices are merely examples of devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be examples and are not intended to be exhaustive and/or inclusive. Furthermore, the examples of the components listed above are also similarly not meant to be exhaustive and/or inclusive.

In accordance with various embodiments of the present disclosure, the methods described herein may be implemented using a hardware computer system that executes software programs. Further, in a non-limiting embodiment, implementations may include distributed processing, component/object distributed processing, and parallel processing. Virtual computer system processing may be constructed to implement one or more of the methods or functionalities as described herein, and a processor described herein may be used to support a virtual processing environment.

As described herein, various embodiments provide for detection of a deepfake within an electronic audio stream via an integrated secure framework environment.

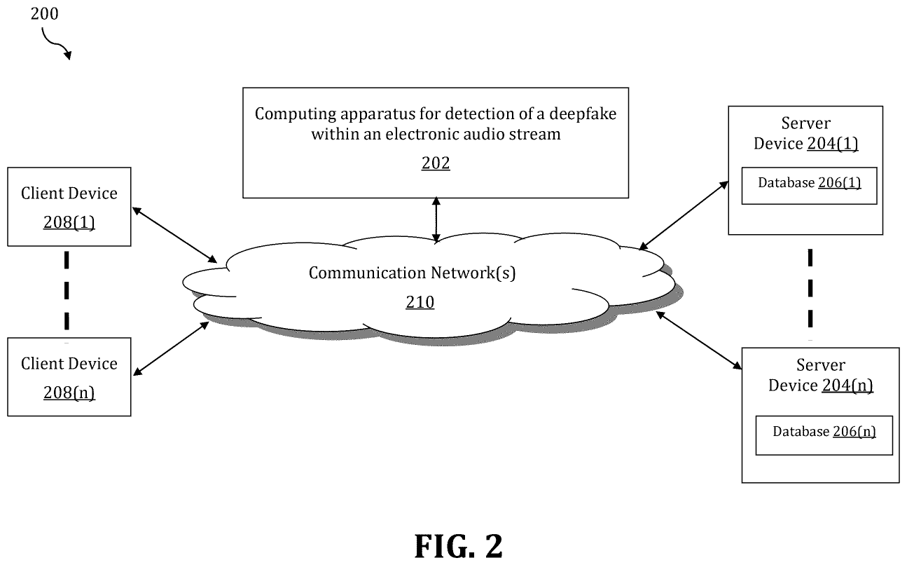

Referring to FIG. 2, a network diagram of a network environment 200 for detection of a deepfake within an electronic audio stream via an integrated secure framework environment may be illustrated. In an embodiment, the method may be executable on any networked computer platform, such as, for example, a personal computer (PC).

The method for detection of a deepfake within an electronic audio stream via an integrated secure framework environment may be implemented by a computing apparatus 202 that implement a detection of a deepfake within an electronic audio stream via the integrated secure framework environment. The computing apparatus 202 may be the same or similar to the computer system 102 as described with respect to FIG. 1. The computing apparatus 202 may store one or more applications that may include executable instructions that, when executed by the computing apparatus 202, cause the computing apparatus 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s) may be located in virtual server(s) running in a cloud-based computing environment rather than being tied to one or more specific physical network computing devices. Also, the application(s) may be running in one or more virtual machines (VMs) executing on the computing apparatus 202. Additionally, in one or more embodiments of this technology, virtual machine(s) running on the computing apparatus 202 may be managed or supervised by a hypervisor.

In the network environment 200 of FIG. 2, the computing apparatus 202 may be coupled to a plurality of server devices 204(1)-204(n) that hosts a plurality of databases 206(1)-206(n), and also to a plurality of client devices 208(1)-208(n) via communication network(s) 210. A communication interface of the computing apparatus 202, such as the network interface 114 of the computer system 102 of FIG. 1, operatively couples and communicates between the computing apparatus 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used. The server devices 204(1)-204(n) and/or the client devices 208(1)-208(n) may provide different computing environments.

The communication network(s) 210 may be the same or similar to the network 122 as described with respect to FIG. 1, although the computing apparatus 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and computing apparatus that efficiently implement a method for detection of a deepfake within an electronic audio stream via an integrated secure framework environment.

By way of example only, the communication network(s) 210 may include local area network(s) (LAN(s)) or wide area network(s) (WAN(s)), and may use TCP/IP over Ethernet and industry-standard protocols, although other types and/or numbers of protocols and/or communication networks may be used. The communication network(s) 210 in this example may employ any suitable interface mechanisms and network communication technologies including, for example, tele-traffic in any suitable form (e.g., voice, modem, and the like), Public Switched Telephone Network (PSTNs), Ethernet-based Packet Data Networks (PDNs), combinations thereof, and the like.

The computing apparatus 202 may be a standalone device or integrated with one or more other devices or apparatuses, such as one or more of the server devices 204(1)-204(n), for example. In one particular example, the computing apparatus 202 may include or be hosted by one of the server devices 204(1)-204(n), and other arrangements are also possible. Moreover, one or more of the devices of the computing apparatus 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the computing apparatus 202 via the communication network(s) 210 according to the HTTP-based and/or script object notation protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store information.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that may interact with the computing apparatus 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an embodiment, at least one client device 208 may be a wireless mobile communication device, i.e., a smart phone.

The client devices 208(1)-208(n) may run interface applications, such as standard web browsers or standalone client applications, which may provide an interface to communicate with the computing apparatus 202 via the communication network(s) 210 in order to communicate user requests and information. The client devices 208(1)-208(n) may further include, among other features, a display device, such as a display screen or touchscreen, and/or an input device, such as a keyboard, for example.

Although the network environment 200 with the computing apparatus 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems described herein are for example purposes, as many variations of the specific hardware and software used to implement the examples are possible, as will be appreciated by those skilled in the relevant art(s).

One or more of the devices depicted in the network environment 200, such as the computing apparatus 202, the server devices 204(1)-204(n), or the client devices 208(1)-208(n), for example, may be configured to operate as a virtual instance on the same physical machine. In other words, one or more of the computing apparatus 202, the server devices 204(1)-204(n), or the client devices 208(1)-208(n) may operate on the same physical device rather than as separate devices communicating through communication network(s) 210. Additionally, there may be more or fewer computing apparatus 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only tele-traffic in any suitable form (e.g., voice and modem), wireless traffic networks, cellular traffic networks, Packet Data Networks (PDNs), the Internet, intranets, and combinations thereof.

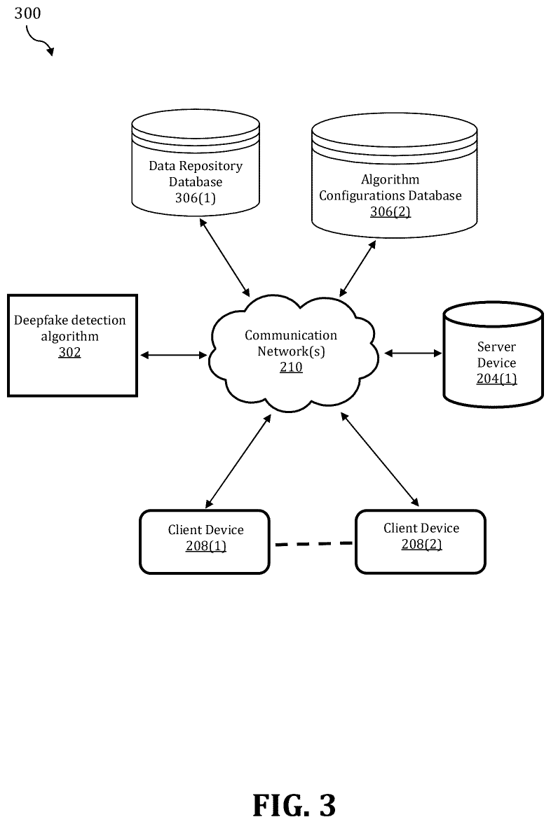

The computing apparatus 202 may be described and illustrated in FIG. 3 as may include a deepfake detection algorithm 302, although it may include other rules, algorithms, policies, modules, databases, or applications, for example. As will be described below, the deepfake detection algorithm 302 may be configured to implement a method of detection of a deepfake within an electronic audio stream via an integrated secure framework environment.

FIG. 3 illustrates a diagram of a system environment 300 for implementing a method for detection of a deepfake within an electronic audio stream an integrated secure framework environment by utilizing the network environment of FIG. 2, which may be illustrated as being executed in FIG. 3. Specifically, a first client device 208(1) and a second client device 208(2) are illustrated as being in communication with computing apparatus 202. In this regard, the first client device 208(1) and the second client device 208(2) may be “clients” of the computing apparatus 202 and are described herein as such. Nevertheless, it is to be known and understood that the first client device 208(1) and/or the second client device 208(2) need not necessarily be “clients” of the computing apparatus 202, or any entity described in association therewith herein. Any additional or alternative relationship may exist between either or both of the first client device 208(1) and the second client device 208(2) and the computing apparatus 202, or no relationship may exist.

Further, computing apparatus 202 may be illustrated as being able to access a data repository database 306(1) and an algorithm configurations database 306(2). The deepfake detection algorithm 302 may be configured to access these databases for implementing the detection of a deepfake within an electronic audio stream via an integrated secure framework environment.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an embodiment, either or both of the first client device 208(1) and the second client device 208(2) may communicate with the computing apparatus 202 via broadband or cellular communication. Of course, these embodiments are merely examples and are not limiting or exhaustive.

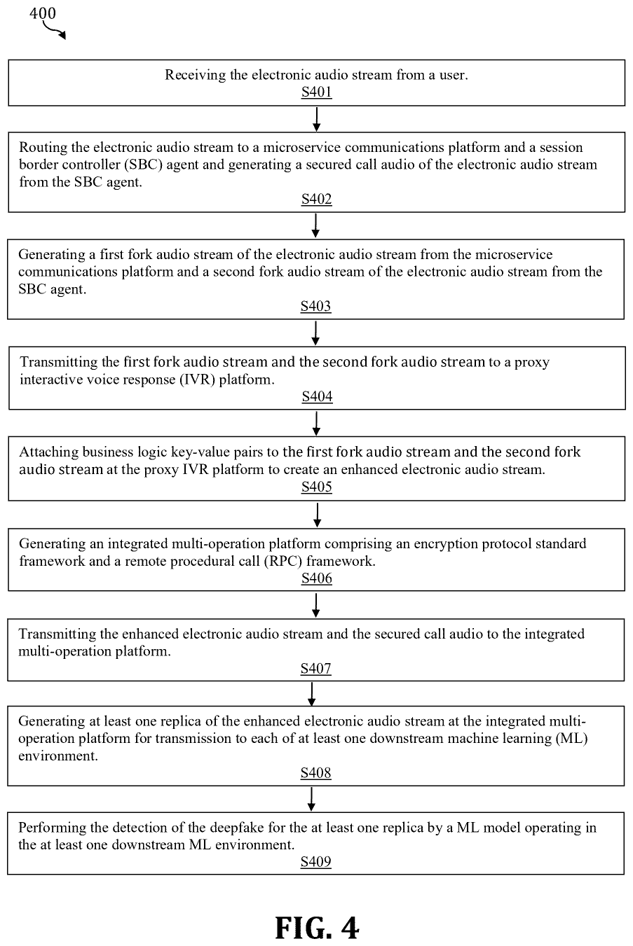

Upon being started, the deepfake detection algorithm 302 may execute a process implementing a method for detection of a deepfake within an electronic audio stream via an integrated secure framework environment. A process for detection of a deepfake within an electronic audio stream via an integrated secure framework environment may be generally indicated at flowchart 400 in FIG. 4.

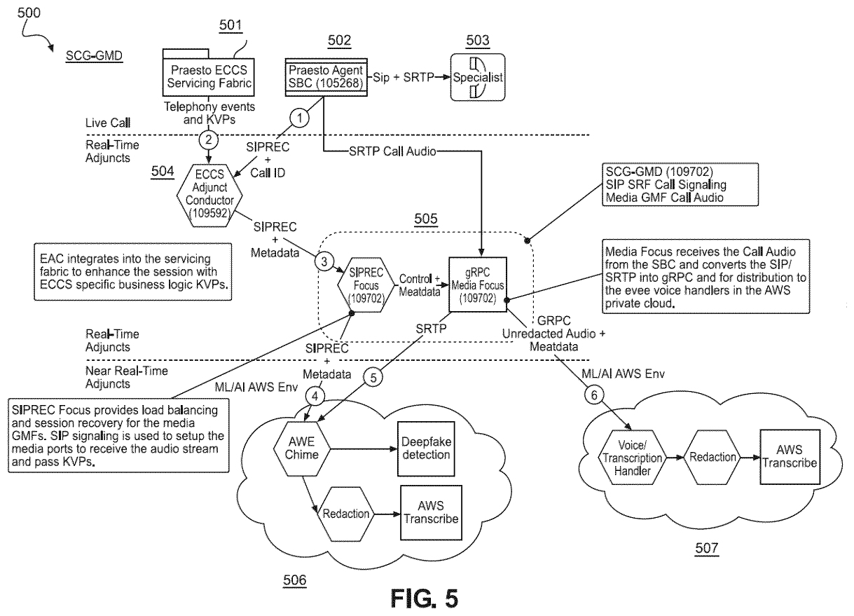

FIG. 4 illustrates a flowchart of a process diagram 400 of a process for detection of a deepfake within an electronic audio stream by an integrated secure framework environment according to an embodiment. The process diagram 400 may be implemented by the system environment 300 of FIG. 3, a network environment 200 of FIG. 2, and the system 100 of FIG. 1. Additionally, the process diagram 400 may be implemented based on the example overview framework 500 of FIG. 5, wherein further details of the various steps may be provided at FIG. 5.

At step S401 of the flowchart process 400, the computing apparatus 202 may receive the electronic audio stream from a user. For instance, a user may make a call to the financial institution, an electronic audio stream of the user's voice may be received by a call center or contact center of the financial institution.

At step S402 of the of the flowchart process 400, the computing apparatus 202 may route the electronic audio stream to a microservice communications platform and a session border controller (SBC) agent and generating a secured call audio of the electronic audio stream from the SBC agent. The SBC agent may be a network device for protecting and regulating communications, e.g., calls. The generating the secured call audio may include securing the electronic audio stream based on a secure real-time transport protocol (SRTP) that provides security protections to the electronic audio stream. The security protections may include at least one from among validation, authentication, encryption, and replay protection of the electronic audio stream.

Continuing with step S402, the microservice communications platform may be a microservice fabric, i.e., a microservices architecture for managing microservice applications. The microservice fabric is shown in FIG. 5. For instance, the electronic audio stream from the user may be routed to both the microservice communications platform and the SBC agent. The electronic audio stream at the SBC agent may then be routed to a call center specialist, as well as to a proxy interactive voice response (IVR) platform (see steps S403 and S404). The proxy IVR platform may be a proxy automated telephone platform providing automated interactive menu choices for user selections. The electronic audio stream at the microservice communications platform may also be routed as described at steps S403 and S404.

At step S403, a first fork audio stream of the electronic audio stream may be generated from the microservice communications platform and a second fork audio stream of the electronic audio stream may be generated from the SBC agent. That is, the routed electronic audio stream may be forked into two audio streams and transmitted to the proxy IVR platform. The first fork may be from the microservice communications platform and is shown via step 1 in FIG. 5 and the second fork may be from the SBC agent and is shown via step 2 in FIG. 5.

At step S404 of the of the flowchart process 400, the computing apparatus 202 may transmit the first fork audio stream and the second fork audio stream to a proxy IVR platform. The proxy IVR platform may be integrated with, i.e., be combined with, the microservice communications platform, and the SBC agent may operate in conjunction with, i.e., it may work with, the microservice communications platform.

At step S405 of the of the flowchart process 400, the computing apparatus 202 may attach, i.e., include, business logic key-value pairs (KVPs) to the first fork audio stream and the second fork audio stream at the proxy IVR platform to create an enhanced electronic audio stream, wherein KVPs denote a fundamental data structure comprising two data elements, with one element being a constant and another element being a variable related to the constant. For instance, the business logic KVPs may be, but not limited to, financial accounts (e.g., banking, savings, credit card, commercial/retail) associated with the user, user identifiers (e.g., name, address, phone number, email, social security number, etc.), source of the call (e.g., a phone number associated with the call such as a caller ID, etc.), etc. That is, the user may be the constant and the other elements being variables associated with the user. An enterprise software application may be integrated with the proxy IVR platform to provide the business logic KVPs.

At step S406 of the of the flowchart process 400, the computing apparatus 202 may generate, i.e., create, an integrated multi-operation platform comprising an encryption protocol standard framework and a remote procedural call (RPC) framework. The encryption protocol standard framework may include a session initiation protocol recording (SIPREC) framework. Further details of the RPC and SIPREC frameworks are provided in FIG. 5.

At step S407 of the of the flowchart process 400, the computing apparatus 202 may transmit the enhanced electronic audio stream and the secured call audio to the integrated multi-operation platform. The transmitting the enhanced electronic audio stream and the secured call audio to the integrated multi-operation platform may include transmitting the enhanced electronic audio stream to the SIPREC framework, and transmitting the secured call audio to the RPC framework. Notably, the computing apparatus 202 may generate a control metadata via the encryption protocol standard framework for input into the RPC framework. The control metadata may be information related to the electronic audio stream as processed by the SIPREC framework for input into the RPC framework.

At step S408 of the of the flowchart process 400, the integrated multi-operation platform may generate at least one replica of the enhanced electronic audio stream at the integrated multi-operation platform for transmission to each of at least one downstream machine learning (ML) environment. The at least one downstream ML environment may include a first ML environment and a second ML environment. The first ML environment may be configured to perform the detection of the deepfake, a first redaction, and a first transcription of the at least one replica. The second ML environment may be configured to perform a second redaction and a second transcription of the at least one replica.

At step S409 of the flowchart process 400, the first ML environment of the at least one downstream ML environment may perform the detection of the deepfake for the at least one replica. Notably, a ML model operating in the first ML environment may perform the deepfake detection.

Continuing with step S409, regarding the first ML environment, the computing apparatus 202 may receive the at least one replica at a remote conferencing platform in the first ML environment and perform dual operations on the at least one replica. A first operation of the dual operations may include performing the deepfake detection of the at least one replica by a ML model. A second operation of the dual operations may include performing the first redaction of the at least one replica that generates a first redacted version of the at least one replica, and performing the first transcribing of the first redacted version for storage on a cloud storage platform.

Regarding the first ML environment, the computing apparatus 202 may generate the at least one replica by converting the secured call audio with a first format with the SRTP to a second format with a RPC protocol via the RPC framework, and transmit the converted secured call audio to the first ML environment. Furthermore, the computing apparatus 202 may also generate the at least one replica by generating a first metadata from the at least one replica via the SIPREC framework for input into the first ML environment. The first metadata may include, but not limited to, user identifiers (e.g., name, address, phone number, email, social security number, etc.), source of the call (e.g., a phone number associated with the call, etc.), etc.

Continuing with step S409, regarding the second ML environment, the computing apparatus 202 may receive the at least one replica at a voice transcription handler in the second ML environment, perform the second redaction of the at least one replica that generates a second redacted version of the at least one replica, and perform the second transcribing of the second redacted version for storage on a cloud storage platform.

Regarding the second ML environment, the computing apparatus 202 may generate an unredacted call audio of the secured call audio and a second metadata of the unredacted call audio via the RPC framework for input into the second ML environment.

FIG. 5 illustrates an example framework 500 for detection of a deepfake within an electronic audio according to an embodiment as described in FIG. 4. The example framework 500 may be initiated, as shown in the live call section, when a user calls into e.g., a financial institution via e.g., a call center of the financial institution. That is, an electronic audio stream from the raw audio signal of the user may be received, wherein the electronic audio stream may then be routed to a microservice communications platform 501 and a session border controller (SBC) agent 502. The microservice communications platform may be a microservice fabric as shown at 501. While an example of the microservice fabric is shown at 501, any such microservice fabric may be utilized.

Thus, a single electronic audio stream may be forked to different endpoints or destinations, e.g., the microservice communications platform 501 and the SBC agent 502. That is, the same customer call may now be forked later downstream applications such as, but not limited to, transcription, recording, deepfake detection, etc., using different application program interfaces (APIs) that may now be operable together and with the microservice communications platform 501 and the SBC agent 502.

The downstream applications will be further described below. The inter-operability of the different APIs may be based on an integrated multi-operation platform with an encryption protocol standard framework and a remote procedural call (RPC) framework, wherein the integrated multi-operation platform is further described below.

Within the live call section, a secured call audio of the electronic audio stream may be generated via the SBC agent. For instance, the secured call audio may be generated by securing the electronic audio stream based on a secure real-time transport protocol (SRTP) that provides security protections to the electronic audio stream. The security protections may include at least one from among validation, authentication, encryption, and replay protection of the electronic audio stream. The secured call audio may be transmitted to integrated multi-operation platform 505.

Additionally, within the live call section, the routed electronic audio stream from the SBC agent may be transmitted to a specialist 503, e.g., a call center specialist, a customer service specialist, etc. The routed electronic audio stream may be secured based on a session initiation protocol (SIP) and STRP.

Continuing with FIG. 5, the real-time adjuncts section may show that the routed electronic audio stream, having been forked into two audio streams, may be transmitted to a proxy interactive voice response (IVR) platform 504. That is, a first fork may be shown via step 1, wherein the electronic audio stream may be generated from the SBC agent to the proxy IVR platform 504. The electronic audio stream may be generated via step 1 based on a session initiation protocol recording (SIPREC) framework and caller ID associated with electronic audio stream. A second fork may be shown via step 2, wherein the electronic audio stream may be generated from the microservice communications platform (e.g., the microservice fabric) for transmission to the proxy IVR platform 504. The electronic audio stream may be generated via step 2 based on telephony events and key-value pairs (KVPs). The KVPs here may be associated with the telephony events.

Continuing with the real-time adjuncts section, the proxy IVR platform 504 may attach business logic key-value pairs (KVPs) to the routed electronic audio data stream at the proxy IVR platform 504 to create an enhanced electronic audio stream. For instance, business logic KVPs may be, but not limited to, financial accounts (e.g., banking, savings, credit card, commercial/retail) associated with the user, user identifiers (e.g., name, address, phone number, email, social security number, etc.), source of the call (e.g., a phone number associated with the call such as a caller ID, etc.), etc. An enterprise software application may be integrated with the proxy IVR platform 504 to provide the business logic KVPs. The proxy IVR platform 504 with the integrated enterprise software application may be integrated with the microservice communications platform 501.

Continuing with the real-time adjuncts section, the enhanced electronic audio stream may be transmitted from the proxy IVR platform 504 to a multi-operation platform 505 that may include an encryption protocol standard framework and a remote procedural call (RPC) framework (step 3). As may be shown in step 3, the enhanced electronic audio stream may be encrypted via proxy IVR platform 504 based on a session initiation protocol recording (SIPREC) for transmission to the multi-operation platform 505. Additionally, metadata of the enhanced electronic audio stream may also be transmitted from the proxy IVR platform 504 to the multi-operation platform 505 (step 3).

Continuing with the real-time adjuncts section, the multi-operation platform 505 may include an encryption protocol standard framework and a RPC framework. The encryption protocol standard framework may include a SIPREC framework (which may be denoted as SIPREC Focus in FIG. 5). The SIPREC framework may transmit control metadata, i.e., control and metadata, to the RPC framework. The RPC framework may be denoted as gRPC Media Focus. The gRPC framework may denote GOOGLE® RPC framework. Although FIG. 5 may show gRPC framework, any applicable RPC framework may be utilized. The RPC framework enables a remote call function via a RPC program that allows for microservices to communicate with each other. The SIPREC framework may also provide load balancing and session recovery for the media framework (e.g., GOOGLE® media framework, which may be denoted as GMFs as shown in FIG. 5). While GMFs may be shown in FIG. 5, any applicable media framework may be utilized. Additionally, SIP signaling may also be used by the SIPREC framework to set up media ports to receive the enhanced electronic audio stream and pass KVPs.

Continuing with the real-time adjuncts section, the RPC framework of the multi-operation platform 505 may receive the secured call audio of the electronic audio stream from the SBC agent 502 and may convert the SIP/SRTP secured aspects of the secured call audio.

Continuing with the real-time adjuncts section, the multi-operation platform 505 may provide a session initiation protocol specialized resource function (SIP SRF) for the enhanced electronic audio stream. The SRF may be a set of functions that provide for control and access to the SIPREC framework and gRPC framework. Additionally, the multi-operation platform 505 may also provide media GMF call audio for the enhanced electronic audio stream.

Continuing with the real-time adjuncts section, the multi-operation platform 505 may generate at least one replica of the enhanced electronic audio stream for transmission to each of at least one downstream machine learning (ML) environment 506 and 507. For example, there may be two different downstream ML environments, a first ML environment 506 and a second ML environment 507. The ML environments may operate in another section of the FIG. 5, notably a near real-time adjuncts section of FIG. 5. The first ML environment 506 may be configured to perform a deepfake detection, a redaction (e.g., a first redaction), and a transcription of a replica (e.g., a first transcription of a first replica). The second ML environment 507 may be configured to perform another redaction (e.g., second redaction) and another transcription of another replica (e.g., a second transcription of a second replica).

Continuing with the real-time adjuncts section, the SIPREC framework of the multi-operation platform 505 may generate and transmit a replica of the enhanced electronic audio stream to the first ML environment 506 (step 4). The replica may be encrypted via the SIPREC framework based on SIPREC for transmission to the first ML environment 506 (step 4). Additionally, metadata of the replica may also be transmitted from the SIPREC framework to the first ML environment 506 (step 4). That is, a transmission from the real-time adjuncts section to the near real-time adjuncts section.

Continuing with the real-time adjuncts section, the RPC framework of the multi-operation platform 505 may generate and transmit a replica of the enhanced electronic audio stream to the first ML environment 506 (step 5). The replica may be encrypted via the RPC framework based on SRTP for transmission to the first ML environment 506 (step 5).

The replicas as generated by the SIPREC framework and the RPC framework for transmission to the first ML environment 506 may denote a first replica. The first ML environment 506 may receive the first replica at a remote conferencing platform in the first ML environment 506. For example, the remote conferencing platform may be AWS® CHIME from AMAZON®, although any applicable remote conferencing platform may be utilized. The first ML environment 506 may perform dual operations on the at least one replica. A first operation of the dual operations may be performing the deepfake detection of the first replica by a ML model that operates within the first ML environment 506. A second operation of the dual operations may be performing a redaction, e.g., a first redaction, of the first replica that generates a first redacted version of the first replica. Another operation of the dual operation may be performing a transcription (e.g., a first transcription) of the first redacted version for storage on a cloud storage platform. The ML model may be any type of ML model or neural network capable of performing deepfake detection and trained using standard training techniques (e.g., back propagation, etc.) to detect deepfakes.

The RPC framework may also generate another replica, which may be denoted as a second replica, for transmission to the second ML environment 507 (step 6). Notably, transmission to a voice transcription handler in the second ML environment 507. The second ML environment 507 may perform another redaction, which may be denoted as second redaction, of the second replica that generates a second redacted version of the second replica. The second ML environment 507 may also perform another transcription, which may be denoted as a second transcription of the second redacted version for storage on a cloud storage platform.

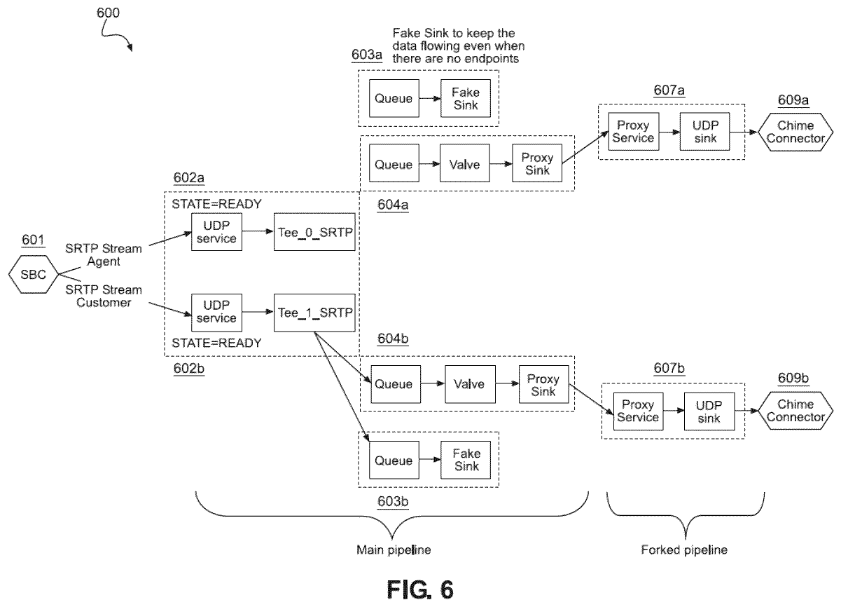

FIG. 6 illustrates an example expanded framework with machine learning (ML) capabilities 600 for detection of a deepfake within an electronic audio stream according to an embodiment as described in FIG. 4. The example expanded framework with ML capabilities 600 may show a SBC 601 that may generate replicas of the electronic audio stream into two different streams within a main pipeline, e.g., a SRTP stream agent via a first user diagram protocol (UDP) service and a SRTP stream customer via a second user diagram protocol (UDP) service. Then, multiple channels may be created (e.g., Tee_0_SRTP and Tee_1_SRTP) that may receive the respective streams from the UDP services. The reference label 602a may represent the first UDP service and Tee_0_SRTP. The reference label 602b may represent the second UDP service and Tee_1_SRTP. Although FIG. 6 shows two streams with two UDP services and two channels, any number of streams, UDP services, and channels may be created. This may occur within a main pipeline.

Continuing with FIG. 6, the stream from Tee_0_SRTP may be transmitted to a first queue (e.g., a first buffer queue) and a first fake sink, which may be represented by 603a. Similarly, the stream from Tee_1_SRTP may be transmitted to a second queue (e.g., a second buffer queue) and a second fake sink, which may be represented by 603b. The fake sink may help to keep data from the electronic audio stream flowing through pipelines even when there may not be endpoints.

Additionally, the stream from Tee_0_SRTP may also be transmitted to a second queue, a valve, and a proxy sink, which may be represented by 604a. Additionally, the stream from Tee_1_SRTP may also be transmitted to a second queue, a valve, and a proxy sink, which may be represented by 604b.

Continuing with FIG. 6, the stream from proxy sink at 604a may be transmitted to a first proxy service and a first UDP sink, which may be represented by 607a. This data may then be transmitted to a remote conferencing platform 609a, e.g. an AWS® CHIME connector from AMAZON®, although any applicable remote conferencing platform may be utilized. That is, the data may be transmitted to the connector for utilization by the downstream applications, such as the ML environments.

Similarly, the stream from proxy sink at 604b may be transmitted to a second proxy service and a second UDP sink, which may be represented by 607b. This data may then be transmitted to a remote conferencing platform 609b, e.g. an AWS® CHIME connector from AMAZON®, although any applicable remote conferencing platform may be utilized. That is, the data may be transmitted to the connector for utilization by the downstream applications, such as the ML environments.

The transition from the proxy sinks 604a and 604b to the proxy services 607a and 607b may denote a transition from the main pipeline to a forked pipeline as shown in FIG. 6. The forked pipeline may provide the data to the connector for utilization by the downstream applications.

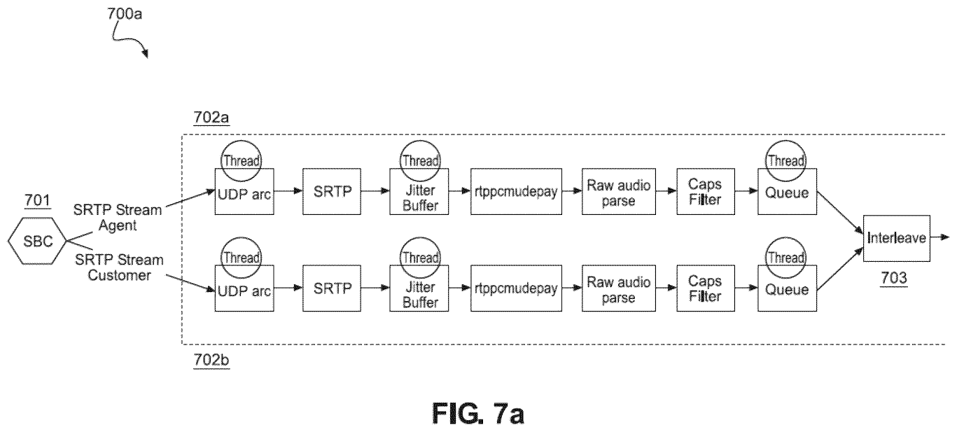

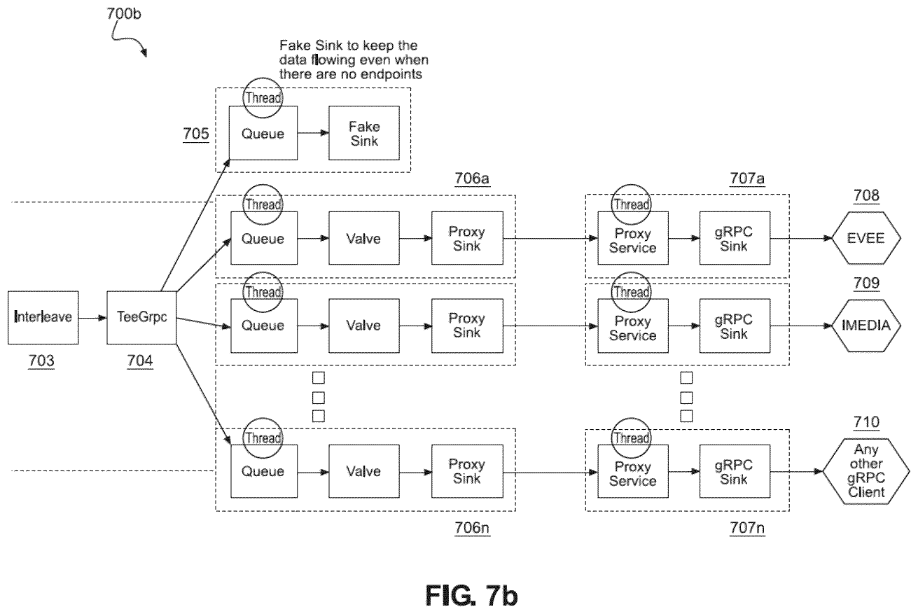

FIG. 7a illustrates an example overview framework expanded with machine learning (ML) capabilities 700a for detection of a deepfake within an electronic audio stream according to an embodiment as described in FIG. 4. The example overview framework expanded with ML capabilities 700a may show a SBC 701 that may generate replicas of the electronic audio stream into two different streams, e.g., a SRTP stream agent with a first thread via a first user diagram protocol (UDP) architecture service and a SRTP stream customer with a second thread via a second user diagram protocol (UDP) architecture service.

The reference label 702a may represent the SRTP stream agent with the first UDP architecture service and the various respective other components. The reference label 702b may represent the SRTP stream agent with the second UDP architecture service and the various respective other components.

Continuing with 702a, the data from the first UDP architecture service may be transmitted and secured via STRP and then sent to a jitter buffer, which may then be sent to a program called rtppcmudepay. The program rtppcmudepay may be used to extract pulse modulation codec μ-law (PCMU) audio from RTP packets. The audio may be the electronic audio stream. Although, the program rtppcmudepay may be shown, any such program for extracting PCMU audio from RTP packets may be utilized.

Continuing with 702a, a raw audio parse may be performed on the extracted audio, i.e., extracted electronic audio stream. Then the data from the raw audio parse may be sent to caps filter, which may be provide limitations on the data. For example, limitations may be related to data format, data length, etc. From the caps filter, the data may then be transmitted to an interleave 703. The interleave 703 may combine the data from the first thread as represented by 702a with the data from the second thread as represented by 702b. The processes and components in 702b are similar to the processes and components as described above for 702a, except that 703b relates to a SRTP stream customer. The process after the interleave 703 may be described in FIG. 7b below, which is a continuation of the FIG. 7a.

FIG. 7b illustrates a continuation of an example overview framework expanded with machine learning (ML) capabilities 700b for detection of a deepfake within an electronic audio stream as described in FIG. 4. As described in FIG. 7a, once the first thread and the second thread have been combined via the interleave 703, the combination may be transmitted to the tee GPRC 704, wherein the tee GPRC 704 may enable creation of multiple channels as shown in FIG. 7b after the tee GPRC 704.

Continuing with FIG. 7b, at least one replica of the electronic audio stream may be generated for transmission to the multiple channels created by the tee GPRC 704. The at least one replica may be transmitted to a queue (e.g., a buffer queue) and a fake sink, which may be represented by 705. The at least one replica may also be transmitted to pipelines, wherein each pipeline may include respective additional queues, valves, and proxy sinks within each pipeline. A first pipeline may be represented by 706a, a second pipeline 706b, and a n^{th} pipeline 706n.

Data from the first pipeline 706a may be transmitted to a first proxy service and a first gRPC sink, wherein the first proxy service and the first gRPC sink may be represented by 707a, which may then be transmitted to EVEE 708. The EVEE 708 may be a down client using gRPC for transcription.

Similarly, data from the second pipeline 706b may be transmitted to a second proxy service and a second gRPC sink, wherein the second proxy service and the second gRPC sink may be represented by 707b, which may then be transmitted to a multi-media production system 709. While FIG. 7b may show a multi-media production system 709 such as iMEDIA®, any applicable multi-media production system may be used.

Similarly, data from n^{th} additional pipelines 706n may also be transmitted to a n^{th} proxy service and a n^{th} gRPC sink, wherein the n^{th} proxy service and the n^{th} gRPC sink may be represented by 707n, which may then be transmitted to any other RPC client 710, i.e., RPC framework. Although FIG. 7b may show gRPC client, any applicable RPC client may be utilized.

Accordingly, the present application provides advantages and a technological improvement over the status quo for the reasons stated above.

When a single electronic audio stream is received by the present application, multiple replicas and media channels as part of the call setup may be generated and a connection with each of the downstream environments may be established. Each of the downstream applications may include various applications including the machine learning (ML) model for detecting deepfakes.

Consider for example, when 20 ms of an electronic audio stream from a user is received from a network via the frameworks as described in FIGS. 6, 7a, and 7b, the process as part of these frameworks in generating the replicas and multiple channels may include buffer queues, jitter buffer management, decryption, and creation of 100 ms packets for each channel that may be connected to an endpoint. The process may also include sending the raw 100 ms bytes to a RPC framework to a downstream application. Additionally, for the same electronic audio stream, SRTP packets may be sent as part of the process to a SRTP based downstream applications.

Furthermore, the frameworks as described in FIGS. 6, 7a, and 7b of the present application have been scaled to enterprise level volumes, i.e., the frameworks of the present application is capable of handling a high-volume of calls and the data associated with them. For instance, the frameworks may be operable as clusters of small sized frameworks that may then be scaled upwards as the volume demand increases. Each cluster may support e.g., 1K concurrent inbound calls and be capable of streaming to multiple downstream environment and applications using different interfaces. For instance, this may be four or more downstream environments and applications.

Although the invention has been described with reference to several embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that may be capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting embodiment, the computer-readable medium may include a solid-state memory such as a memory card or other package that houses one or more non-volatile read-only memories. Further, the computer-readable medium may be a random-access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure may be considered to include any computer-readable medium or other equivalents and successor media, in which data or instructions may be stored.

Although the present application describes specific embodiments which may be implemented as computer programs or code segments in computer-readable media, it may be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for detection of a deepfake within an electronic audio stream by an integrated secure framework environment, the method being implemented by at least one processor, the method comprising:
receiving the electronic audio stream from a user;
routing the electronic audio stream to a microservice communications platform and a session border controller (SBC) agent and generating a secured call audio of the electronic audio stream from the SBC agent;
generating a first fork audio stream of the electronic audio stream from the microservice communications platform and a second fork audio stream of the electronic audio stream from the SBC agent;
transmitting the first fork audio stream and the second fork audio stream to a proxy interactive voice response (IVR) platform;
attaching business logic key-value pairs to the first fork audio stream and the second fork audio stream at the proxy IVR platform to create an enhanced electronic audio stream;
generating an integrated multi-operation platform comprising an encryption protocol standard framework and a remote procedural call (RPC) framework;
transmitting the enhanced electronic audio stream and the secured call audio to the integrated multi-operation platform;
generating at least one replica of the enhanced electronic audio stream at the integrated multi-operation platform for transmission to each of at least one downstream machine learning (ML) environment; and
performing the detection of the deepfake for the at least one replica by a ML model operating in the at least one downstream ML environment.

2. The method of claim 1, wherein the encryption protocol standard framework comprises a session initiation protocol recording (SIPREC) framework; and
wherein the at least one downstream ML environment comprises a first ML environment configured to perform the detection of the deepfake, a first redaction, and a first transcription of the at least one replica and a second ML environment configured to perform a second redaction and a second transcription of the at least one replica.

3. The method of claim 2, further comprising:
receiving the at least one replica at a remote conferencing platform in the first ML environment; and
performing dual operations on the at least one replica;
wherein a first operation of the dual operations comprises performing the deepfake detection of the at least one replica by a ML model; and
wherein a second operation of the dual operations comprises:
performing the first redaction of the at least one replica that generates a first redacted version of the at least one replica, and
performing the first transcribing of the first redacted version for storage on a cloud storage platform.

4. The method of claim 2, further comprising:
receiving the at least one replica at a voice transcription handler in the second ML environment;
performing the second redaction of the at least one replica that generates a second redacted version of the at least one replica; and
performing the second transcribing of the second redacted version for storage on a cloud storage platform.

5. The method of claim 2, wherein the transmitting the enhanced electronic audio stream and the secured call audio to the integrated multi-operation platform comprises:
transmitting the enhanced electronic audio stream to the SIPREC framework; and
transmitting the secured call audio to the RPC framework.

6. The method of claim 2, wherein the generating the secured call audio comprises securing the electronic audio stream based on a secure real-time transport protocol (SRTP) that provides security protections to the electronic audio stream; and
wherein the security protections comprise at least one from among validation, authentication, encryption, and replay protection of the electronic audio stream.

7. The method of claim 6, wherein the generating the at least one replica further comprises:
generating a first metadata from the at least one replica via the SIPREC framework for input into the first ML environment.

8. The method of claim 6, wherein the generating the at least one replica further comprises:
converting the secured call audio with a first format comprising the SRTP to a second format with a RPC protocol via the RPC framework; and
transmitting the converted secured call audio to the first ML environment.

9. The method of claim 6, wherein the generating the at least one replica further comprises:
generating an unredacted call audio of the secured call audio and a second metadata of the unredacted call audio via the RPC framework for input into the second ML environment.

10. The method of claim 1, further comprising:
generating a control metadata via the encryption protocol standard framework for input into the RPC framework.

11. A computing apparatus for detection of a deepfake within of an electronic audio stream by an integrated secure framework environment, comprising:
a processor;
a memory;
a display; and
a communication interface coupled to each of the processor, the memory, and the display, wherein the processor is configured to implement the integrated secure framework environment to:
receive the electronic audio stream from a user;
route the electronic audio stream to a microservice communications platform and a session border controller (SBC) agent and generating a secured call audio of the electronic audio stream from the SBC agent;
generate a first fork audio stream of the electronic audio stream from the microservice communications platform and a second fork audio stream of the electronic audio stream from the SBC agent;
transmit the first fork audio stream and the second fork audio stream to a proxy interactive voice response (IVR) platform;
attach business logic key-value pairs to the first fork audio stream and the second fork audio stream at the proxy IVR platform to create an enhanced electronic audio stream;
generate an integrated multi-operation platform comprising an encryption protocol standard framework and a remote procedural call (RPC) framework;
transmit the enhanced electronic audio stream and the secured call audio to the integrated multi-operation platform;
generate at least one replica of the enhanced electronic audio stream at the integrated multi-operation platform for transmission to each of at least one downstream machine learning (ML) environment; and
perform the detection of the deepfake for the at least one replica by a ML model operating in the at least one downstream ML environment.

12. The computing apparatus of claim 11, wherein the encryption protocol standard framework comprises a session initiation protocol recording (SIPREC) framework; and
wherein the at least one downstream ML environment comprises a first ML environment configured to perform the detection of the deepfake, a first redaction, and a first transcription of the at least one replica and a second ML environment configured to perform a second redaction and a second transcription of the at least one replica.

13. The computing apparatus of claim 12, wherein the processor is further configured to implement the integrated secure framework environment to:
receive the at least one replica at a remote conferencing platform in the first ML environment; and
perform dual operations on the at least one replica;
wherein the processor performs a first operation of the dual operations by performing the deepfake detection of the at least one replica by a ML model; and
wherein the processor performs a second operation of the dual operations by:
performing the first redaction of the at least one replica that generates a first redacted version of the at least one replica, and
performing the first transcribing of the first redacted version for storage on a cloud storage platform.

14. The computing apparatus of claim 12, wherein the processor is further configured to implement the integrated secure framework environment to:
receive the at least one replica at a voice transcription handler in the second ML environment;
perform the second redaction of the at least one replica that generates a second redacted version of the at least one replica; and
perform the second transcribing of the second redacted version for storage on a cloud storage platform.

15. The computing apparatus of claim 12, wherein the processor is further configured to implement the integrated secure framework environment to:
transmit the enhanced electronic audio stream and the secured call audio to the integrated multi-operation platform by:
transmitting the enhanced electronic audio stream to the SIPREC framework, and
transmitting the secured call audio to the RPC framework; and
generate the secured call audio by securing the electronic audio stream based on a secure real-time transport protocol (SRTP) that provides security protections to the electronic audio stream,
wherein the security protections comprise at least one from among validation, authentication, encryption, and replay protection of the electronic audio stream.

16. The computing apparatus of claim 12, wherein the processor is further configured to implement the integrated secure framework environment to:
generate the at least one replica further by:
generating a first metadata from the at least one replica via the SIPREC framework for input into the first ML environment;
converting the secured call audio with a first format comprising the SRTP to a second format with a RPC protocol via the RPC framework;
transmitting the converted secured call audio to the first ML environment; and
generating an unredacted call audio of the secured call audio and a second metadata of the unredacted call audio via the RPC framework for input into the second ML environment.

17. A non-transitory computer readable storage medium storing instructions for detection of a deepfake within an electronic audio stream by an integrated secure framework environment, the non-transitory computer readable storage medium comprising executable code which, when executed by a processor, causes the processor to implement the integrated secure framework environment to:
receive the electronic audio stream from a user;
route the electronic audio stream to a microservice communications platform and a session border controller (SBC) agent and generating a secured call audio of the electronic audio stream from the SBC agent;
generate a first fork audio stream of the electronic audio stream from the microservice communications platform and a second fork audio stream of the electronic audio stream from the SBC agent;
transmit the first fork audio stream and the second fork audio stream to a proxy interactive voice response (IVR) platform;
attach business logic key-value pairs to the first fork audio stream and the second fork audio stream at the proxy IVR platform to create an enhanced electronic audio stream;
generate an integrated multi-operation platform comprising an encryption protocol standard framework and a remote procedural call (RPC) framework;
transmit the enhanced electronic audio stream and the secured call audio to the integrated multi-operation platform;
generate at least one replica of the enhanced electronic audio stream at the integrated multi-operation platform for transmission to each of at least one downstream machine learning (ML) environment; and
perform the detection of the deepfake for the at least one replica by a ML model operating in the at least one downstream ML environment.

18. The non-transitory computer readable storage medium of claim 17, wherein the encryption protocol standard framework comprises a session initiation protocol recording (SIPREC) framework; and
wherein the at least one downstream ML environment comprises a first ML environment configured to perform the detection of the deepfake, a first redaction, and a first transcription of the at least one replica and a second ML environment configured to perform a second redaction and a second transcription of the at least one replica.

19. The non-transitory computer readable storage medium of claim 18, wherein the executable code further causes the processor to implement the integrated secure framework environment to:
receive the at least one replica at a remote conferencing platform in the first ML environment; and
perform dual operations on the at least one replica;
wherein the processor performs a first operation of the dual operations by performing the deepfake detection of the at least one replica by a ML model; and
wherein the processor performs a second operation of the dual operations by:
performing the first redaction of the at least one replica that generates a first redacted version of the at least one replica, and
performing the first transcribing of the first redacted version for storage on a cloud storage platform.

20. The non-transitory computer readable storage medium of claim 18, wherein the executable code further causes the processor to implement the integrated secure framework environment to:
receive the at least one replica at a voice transcription handler in the second ML environment;
perform the second redaction of the at least one replica that generates a second redacted version of the at least one replica; and
perform the second transcribing of the second redacted version for storage on a cloud storage platform.
